(19) United States
(12) Patent Application Publication
(10) Pub. No.: US 2013/0057845 A1
(43) Pub. Date: Mar. 7, 2013

(54) CONTROL AND SWITCH DEVICE FOR INNER LIGHT PATH OF LASER DISTANCE METER

(71) Applicants: Dezhong Yang, Nanjing (CN); Yangjian Xu, Nanjing (CN)

(72) Inventors: Dezhong Yang, Nanjing (CN); Yangjian Xu, Nanjing (CN)

(73) Assignee: CHERVON (HK) LIMITED, Wanchai (HK)

(21) Appl. No.: 13/600,407

(22) Filed: Aug. 31, 2012

(30) Foreign Application Priority Data
Sep. 5, 2011 (CN) 201110260258.1

(51) Int. Cl. G01C 3/02

(52) U.S. Cl. 356/3

(57) ABSTRACT

A control and switch device for an inner light path of a meter distance meter includes: a generating device for emitting a polarized light; a liquid crystal box for deflecting the polarized light emitted from the generating device; a transparent medium positioned near the Brewster's angle formed by an emergent light emitted from the liquid crystal box; and a polarizer positioned in the direction of an emergent light emitted from the transparent medium.

### RELATED APPLICATION INFORMATION

This application claims the benefit of CN 201110260258.1, filed on Sep. 5, 2011, the disclosure of which is incorporated herein by reference in its entirety.

### BACKGROUND

This invention relates to distance meters, and more particular, to a control and switch device for an inner light path of a laser distance meter.

The calibration of the inner light path of the laser distance meter is one of core technologies for achieving the distance measuring, ensuring measuring accuracy and improving the ability of distance measuring. A mechanical transmission structure is generally used to control and switch the inner light path of the distance meter. However, in the mechanical transmission structure, vibration will be certainly caused due to mechanical movement and it will impact the accuracy of the control and switch of the light path. In addition, the mechanical transmission structure for the inner light path of the distance meter generally has complicated structure.

### SUMMARY

The object of the present invention is to solve the control and switch problem of inner light path of the laser distance meter and provides a device which can control and switch the inner light path easily, accurately and reliably.

In order to solve the above problem, the present invention provides a control and switch device for an inner light path of a laser distance meter, including a multi-mode laser head capable of emitting a multi-mode polarized light; a first polarizer positioned adjacent to the multi-mode laser head for receiving the multi-mode polarized light and emitting a linear polarized light with a desired power, the first polarizer being capable of rotating around the optical axis for changing the power of the linear polarized light; a liquid crystal box capable of deflecting the linear polarized light emitted from the first polarizer, a deflected angle of the liquid crystal box relative to the incident polarized light is about 0° or about 90°; a transparent medium positioned near the Brewster's angle formed by an emergent light emitted from the liquid crystal box with an error in the range from −10° to 10°, the transparent medium is capable of dividing the incident light into at least two rays of linear polarized light in different directions; and a second polarizer positioned in the direction of an emergent light emitted from the transparent medium.

In order to solve the above problem, the present invention also provides a control and switch device for the inner light path of a laser distance meter, including: a generating device for emitting a polarized light; a liquid crystal box for deflecting the polarized light emitted from the generating device; a transparent medium positioned near the Brewster's angle formed by an emergent light emitted from the liquid crystal box with an error between 10° and −10°; and a polarizer positioned in the direction of an emergent light emitted from the transparent medium.

The control and switch device for the inner light path of a laser distance meter changes the traditional control manner of mechanical transmission, and it is controlled by a circuit. Thus, the signal interference is decreased, and the accuracy and reliability of calibration for the inner light path can be ensured, so that the measuring accuracy can be ensured. The present invention with a simple structure has a better accuracy and reliability, which provides a new direction for the development of design to the inner light path of the laser distance meter.

### BRIEF DESCRIPTION OF THE DRAWINGS

FIG. 1 is a schematic view of the Brewster's law;

FIG. 2 is a structural schematic view of the present invention;

FIG. 3 is a schematic view of a state of an emission light path;

FIG. 4 is a schematic view of a state of calibrating an inner light path.

### DETAILED DESCRIPTION

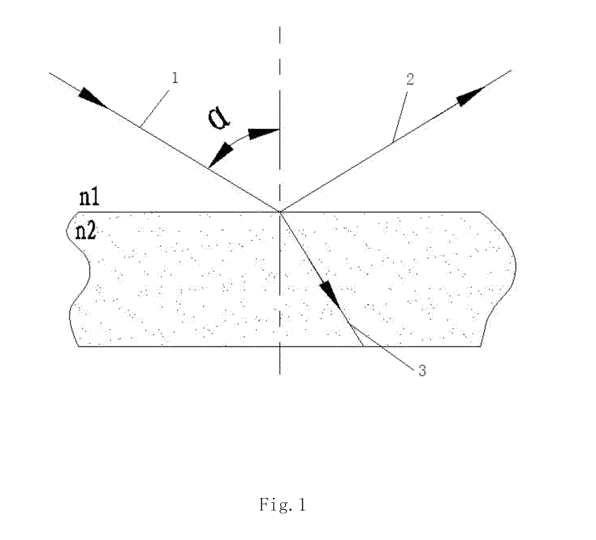

The Brewster's law is utilized by the present invention, which means that when the incident angle of an incident light 1 is a particular value α, a reflected light 2 becomes a completely linearly polarized light, a refracted light 3 becomes a partial polarized light perpendicular to the reflected light 2, and the current incident angle a is referred to as the Brewster's angle, as shown in FIG. 1.

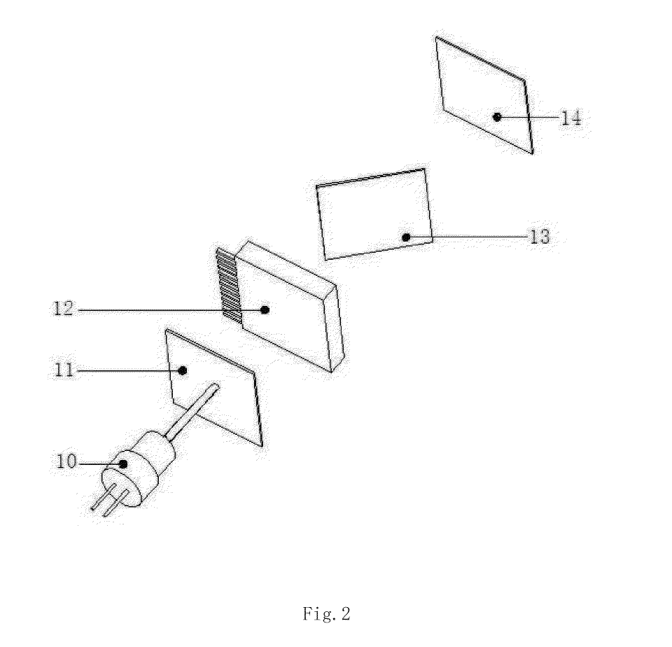

Referring to FIG. 2, the device of the present invention includes a multi-mode laser head LD 10, a first polarizer 11, a liquid crystal box 12, a transparent medium 13, and a second polarizer 14 positioned in that order.

The multi-mode laser head LD10 is capable of emitting multi-mode polarized laser.

The polarized light whose polarization direction is the same as the polarization direction of the first polarizer 11 and the second polarizer 14 can pass through the first polarizer 11 and the second polarizer 14, and the polarized light whose polarization direction is particular to the polarization direction of the first polarizer 11 and the second polarizer 14 can be shielded by the first polarizer 11 and the second polarizer 14.

The transparent medium 13 is placed in a position near the Brewster's angle of the polarized light after passing through the liquid crystal box 12. Because the present invention allows a certain tolerance, it is unnecessary to place the transparent medium in the position on the Brewster's angle accurately, and it can be placed between the Brewster's angle plus 10° and the Brewster's angle minus 10°. The transparent medium 13 in the present embodiment is a common glass, and it can also be any component that can divide the laser into two or more rays of polarized light in different directions, such as a polarized beam splitter (PBS), a polarizing spectroscope or a rotary polarizing screen, etc.

By controlling the voltage on the liquid crystal box 12, the polarizing direction of the laser light that enters into the liquid crystal box 12 can be changed.

The control and switch process of the inner light path of the present invention is as follows:

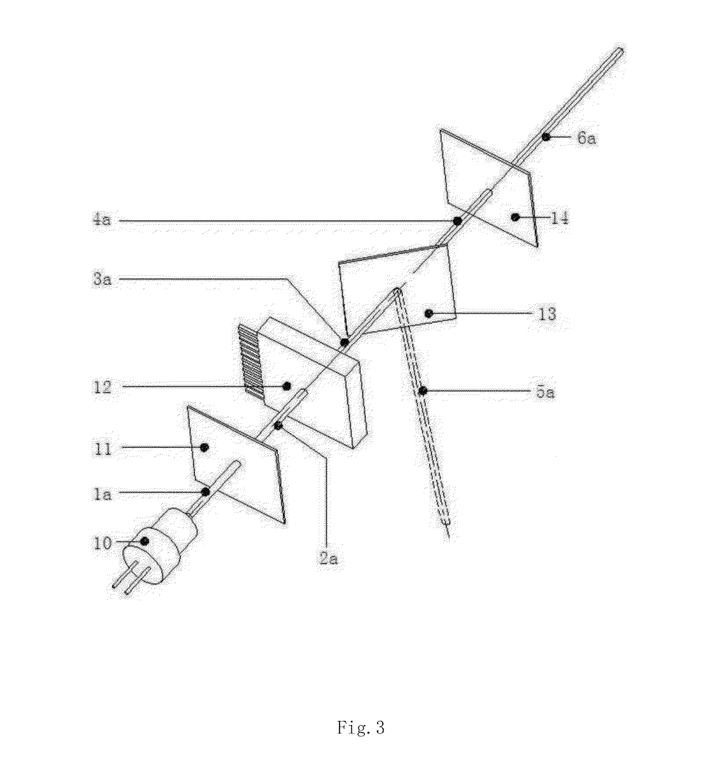

Referring to FIG. 3, a multi-mode polarized light 1 a emitted from the multi-mode laser head LD10 enters into the first polarizer 11. By adjusting the angle of the first polarizer 11, the first polarizer 11 is rotated around the optical axis in the space to change the current light power. At the current position, the light la perpendicularly enters into the first polarizer 11, and the emergent power of the light reaches the largest value and it becomes a linear polarized light 2a with a desired power. The linear polarized light 2a then enters into the liquid crystal box 12 that has an angle β. The polarization direction of the light 2a is deflected by nearly 90° to form a polarized light 3a by controlling the voltage applied on the liquid crystal box 12 to become null, i.e. without any voltage applied thereon. Subsequently, the polarized light 3a is transmitted through the transparent medium 13 to form a light 4a. At this time, no reflected light is formed or only a reflected light 5a with a lower power is generated. If the initial polarization direction of the laser head makes it impossible to form a reflected light on the surface of the transparent medium, the liquid crystal box does not change the polarization direction of the laser. Next, a light 4a passes through the second polarizer 14 and thus an emergent light 6a with a high power is formed, and the polarization direction of the polarizer 14 causes the light 5a and the light 6a to repel each other and the light 5a with a lower power does not impact the measuring function of the emergent light 6a.

When the inner light path is at the condition of the emitted light path, the light power can be adjusted so as to form the emergent light 6a.

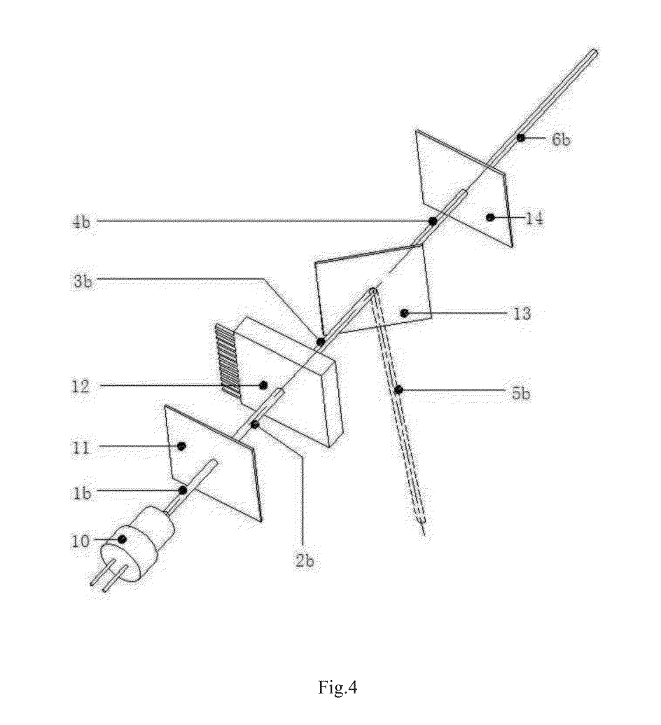

Referring to FIG. 4, a multi-mode polarized light 1b emitted from the multi-mode laser head LD 10 enters into the first polarizer 11. By adjusting the angle of the first polarizer 11, the first polarizer 11 is rotated around the optical axis in the space to change the current optical power so that the light 1b is rotated away from a position where the light 1b enters perpendicularly to a position perpendicular to the polarizer 11, thus the power of the emergent light is reduced and a linear polarized light 2b with the desired power is obtained. Then, the linear polarized light 2b enters into the liquid crystal box 12 that has an angle of β+90°. A voltage created by a circuit connected to liquid crystal box 12 is applied on the liquid crystal box 12 is controlled such that the polarization direction of the light 2b can not be changed by the liquid crystal box 12, that is, the polarization direction of the light 2b does not have a deflection or has a deflection approximate to 0°, and a polarized light 3b is formed. Next, the polarized light 3b passes through the transparent medium 13 and is reflected to form a linear polarized light 5b with a high power. The polarization direction of the laser is not changed by the liquid crystal box if the initial polarization direction of the laser head enables it to generate a reflected light on the surface of the transparent medium, otherwise the polarization direction of the laser is changed by the liquid crystal box such that a reflected light is formed on the surface of the transparent medium, and the reflected linear polarized light 5b with a high power is utilized to calibrate the inner light path. At the same time, the polarized light 3b passes through the transparent medium 13 and forms a light 4b. Subsequently, the light 4b is shielded by the second polarizer 14 or generates an emergent light 6b with a lower power; and the light 5b and light 6b repel each other, and the emergent light 6b with a lower power does not impact the calibration function of the inner calibration light path.

When the inner light path is at the condition for calibration, it can shield the emergent light path and forms an inner light path for calibration.

The control and switch device for the inner light path of a laser distance meter changes the traditional control manner of mechanical transmission, and it is controlled by a circuit connected to the liquid crystal box. Thus, the signal interference is decreased, and the accuracy and reliability of calibration for the inner light path can be ensured, so that the measuring accuracy can be ensured. The present invention with a simple structure has a better accuracy and reliability, which provides a new direction for the development of design to the inner light path of the laser distance meter.

It should be noted that the first polarizer 11 may be omitted, and a single-mode laser head may used as a generating device for emitting a polarized light. The above preferred embodiments disclose the present invention. It should be pointed out that, for one of ordinary skilled in the art, many modifications and transformations also can be carried out without departing from the technical principal of the present invention, which are also considered as falling within the protection scope of the present invention.

What is claimed is:

1. A control and switch device for an inner light path of a laser distance meter, comprising:
a multi-mode laser head capable of emitting a multi-mode polarized light;
a first polarizer positioned adjacent to the multi-mode laser head for receiving the multi-mode polarized light and emitting a linear polarized light with a desired power, the first polarizer being capable of rotating around the optical axis for changing the power of the linear polarized light;
a liquid crystal box capable of deflecting the linear polarized light emitted from the first polarizer, a deflected angle of the liquid crystal box relative to the incident polarized light is about 0° or about 90°;
a transparent medium positioned near the Brewster's angle formed by an emergent light emitted from the liquid crystal box with an error in the range from −10° to 10°, the transparent medium is capable of dividing the incident light into at least two rays of linear polarized light in different directions; and
a second polarizer positioned in the direction of an emergent light emitted from the transparent medium.

2. The control and switch device for an inner light path of a laser distance meter according to claim 1, in a state of an emission light path, a deflected angle of the liquid crystal box relative to the incident polarized light is about 90°, in a state of calibrating an inner light path, a deflected angle of the liquid crystal box relative to the incident polarized light is about 0°.

3. The control and switch device for an inner light path of a laser distance meter according to claim 2, wherein the deflected angle is controlled by a voltage applied on the liquid crystal box.

4. The control and switch device for an inner light path of a laser distance meter according to claim 1, wherein the transparent medium is one of a common glass, a polarized beam splitter, a polarizing spectroscope and a rotary polarizing screen.

5. A control and switch device for an inner light path of a laser distance meter, comprising:
a generating device capable of emitting a polarized light;
a liquid crystal box capable of deflecting the polarized light emitted from the generating device;
a transparent medium positioned near the Brewster's angle formed by an emergent light emitted from the liquid crystal box with an error in the range from −10° to 10°; and
a polarizer positioned in the direction of an emergent light emitted from the transparent medium.

6. The control and switch device for an inner light path of a laser distance meter according to claim 5, wherein a deflected angle of the liquid crystal box relative to the incident polarized light is 0° or 90°, allowing a tolerance between 10° and −10°.

7. The control and switch device for an inner light path of a laser distance meter according to claim 6, wherein the deflected angle is controlled by a voltage applied on the liquid crystal box.

8. The control and switch device for an inner light path of a laser distance meter according to claim 5, wherein the transparent medium is capable of dividing the incident light into two or more rays of linear polarized light in different directions .

9. The control and switch device for an inner light path of a laser distance meter according to claim 5, wherein the transparent medium is one of a common glass, a polarized beam splitter, a polarizing spectroscope and a rotary polarizing screen.

10. The control and switch device for an inner light path of a laser distance meter according to claim 5, wherein the generating device is a single-mode laser head.

11. The control and switch device for an inner light path of a laser distance meter according to claim 5, wherein the generating device comprises a multi-mode laser head and another polarizer that deflects a multi-mode polarized laser emitted from the multi-mode laser head.
